(19) United States
(12) Patent Application Publication
(10) Pub. No.: US 2004/0244241 A1
(43) Pub. Date: Dec. 9, 2004

(54) Method of identifying and locating an object

(76) Inventor: Yvonne S. Knickerbocker, Santa Monica, CA (US)

Correspondence Address: Yvonne S. Knickerbocker, 1054 Yale Street, Santa Monica, CA, 90403, US

(21) Appl. No.: 10/453,291

(22) Filed: Jun. 3, 2003

(51) Int. Cl. G09F 3/10

(52) U.S. Cl. 40/299.01

(57) ABSTRACT

Tags which would be made up in an abundance of dimensions, sizes, shapes, colors, fabrics, synthetics, with designs such as animals, fruits, vegetables, plants, flowers, numerals, symbols, initials, words, figures, flags, shapes, sign language, sea life, zodiac signs, smiley faces, etc. Said device would be attached to an object by any of several means, including a strap, ribbon, rubber/plastic band, chain, or clip.

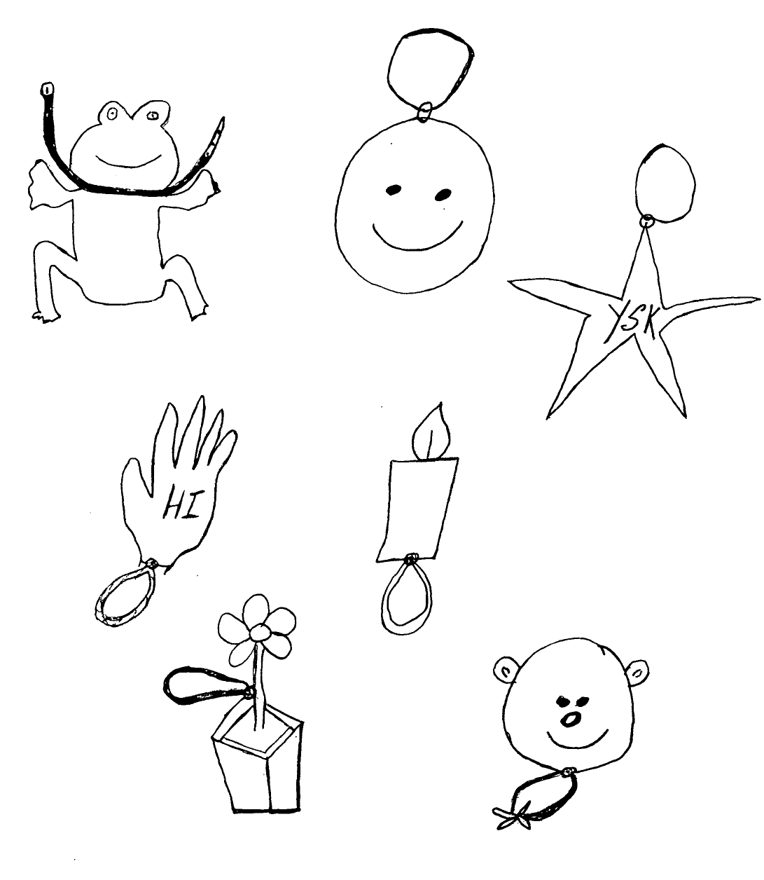

### FIELD OF INVENTION

This invention is related to a device (tag), specifically that which will make an object more easy to identify, locate and/or retrieve.

### DESCRIPTION OF PRIOR ART

People commonly place a tag on their objects, including but not limited to luggage, backpacks, computers, music bags, briefcases, packages, clothing, sports equipment and many other objects.

Ordinarily these tags are small and similar and objects are hard to identify, locate and/or retrieve without sometimes looking at many similar such objects, which is also time consuming.

One is often anxious when trying to locate an object, particularly at an airport, where most of the luggage is similar in color and style.

A device which would be attached, with or without a space for personal information, to an object will made up in an abundance of dimensions, sizes, shapes, colors, fabrics, synthetics, with designs such as animals, fruits, vegetables, plants, flowers, numerals, symbols, initials, words, figures, flags, shapes, sign language, sea life, zodiac signs, smiley faces, etc. which will make it much easier to more quickly identify, locate and/or retrieve your objects.

### OBJECTS AND ADVANTAGES

Accordingly, besides the objects and advantages of the device described in my above patent, several advantages are:

a. Easier and quicker to identify your object;

b. Easier and quicker to locate your object;

c. Easier and quicker to retrieve your object;

d. Children could locate their objects easily;

e. Groups could locate their objects easily;

f. Saves time because your object would be easily recognizable;

g. Variety of tags would make objects more unique;

h. Variety of tags would make objects more unique and less likely for someone to pick up the wrong objects in error.

### DRAWING FIGURES

The drawings show a sample of the device (tags). The tags would be attached to the objects by several methods, including a strap, ribbon, rubber/plastic band, chain or clip.

### SUMMARY

It is an object of this invention to make it easier to identify, locate and/or retrieve an object.

It is a further object of this invention to make it quicker to retrieve an object.

The invention is a tag, which would be attached to an object by any of several means, including a strap, ribbon, band, chain, or clip.

### DESCRIPTION

Tags which would be attached will made up in an abundance of dimensions, sizes, shapes, colors, fabrics, synthetics, with designs such as animals, fruits, vegetables, plants, flowers, numerals, symbols, initials, words, figures, flags, shapes, sign language, sea life, zodiac signs, smiley faces, etc.

### OPERATION

The invention is a tag that would be attached to an object by any of several means, including a strap, ribbon, rubber/plastic band, chain, or clip.

### SUMMARY, RAMIFICATIONS, AND SCOPE

Accordingly, one can see that this invention will be of great advantage in aiding the quick identification, location and/or retrieval of an object.

Although the description contains many specifications, these should not be construed as limiting the scope of the invention but as merely providing illustrations of some of the embodiments of the invention.

Thus the scope of the invention should be determined by the appended claims and their legal equivalents, rather than only by the examples given.

What is claimed are:

1. Said device when attached comprises of a unique means for identifying, locating and/or retrieving an object.

2. Said device when attached comprises of a unique means for visually identifying, locating and/or retrieving an object.

3. Said device when attached comprises of a timesaving means for visually identifying, locating and/or retrieving an object.

4. An object locating system comprising of a device which will made up in an abundance of dimensions, sizes, shapes, colors, fabrics, synthetics, with designs such as animals, fruits, vegetables, plants, flowers, numerals, symbols, initials, words, figures, flags, shapes, sign language, sea life, zodiac signs, smiley faces. Said device would be attached to an object by any of several means, e.g. a strap, ribbon, band, chain, or clip.
